(19) United States
(12) Patent Application Publication
(10) Pub. No.: US 2012/0051483 A1
(43) Pub. Date: Mar. 1, 2012

(54) WELDED PORTION INSPECTION APPARATUS OF REACTOR PRESSURE VESSEL

(75) Inventors: Yosuke TAKATORI, Hitachi (JP); Kenichi OTANI, Hitachi (JP); Hidetaka KOMURO, Kitaibaraki (JP); Satoshi OKADA, Hitachi (JP); Ryosuke KOBAYASHI, Hitachi (JP)

(73) Assignee: HITACHI-GE NUCLEAR ENERGY, LTD., Ibaraki (JP)

(21) Appl. No.: 13/216,483

(22) Filed: Aug. 24, 2011

(30) Foreign Application Priority Data
Aug. 24, 2010 (JP) 2010-187013

(51) Int. Cl. G21C 17/00

(52) U.S. Cl. 376/249

(57) ABSTRACT

A welded portion inspection apparatus of a reactor pressure vessel moves on an outside surface of the reactor pressure vessel, and is provided with a scan portion having a sensor for detecting a state of the welded portion to be inspected. The apparatus has a first scan axis with a pedestal having the sensor installed for moving the sensor in a predetermined first direction to perform scanning, and a second scan axis orthogonal to the first scan axis for moving the first scan axis in a predetermined second direction. Drive portions are installed removably on both sides of the scan portion for moving the scan portion to a position of the welded portion to be inspected, and a motor is provided for driving the drive portions. The drive portions include a plurality of magnets which are endlessly formed in a line.

### CLAIM OF PRIORITY

The present application claims priority from Japanese patent application serial No. 2010-187013, filed on Aug. 24, 2010, the content of which is hereby incorporated by reference into this application.

### BACKGROUND OF THE INVENTION

1. Field of the Invention

The present invention relates to a welded portion inspection apparatus of a reactor pressure vessel of a trackless type for inspecting a welded portion between the pressure vessel of a nuclear power plant or others and an intra-reactor structure installed in the pressure vessel or a welded portion of the pressure vessel.

Further, the present invention more particularly relates to a welded portion inspection apparatus of a reactor pressure vessel of a trackless type for inspecting a narrow portion of the outside environment of the pressure vessel due to a surrounding structure, where the inspection apparatus for inspecting the inside welded portion of the reactor pressure vessel which is a position to be inspected moves and inspects, from the outside of the pressure vessel.

2. Description of Related Art

In the inspection of the inside welded portion of the reactor pressure vessel of the nuclear power plant or others or the welded portion between the reactor pressure vessel and an intra-reactor structure installed in the pressure vessel, the welded portion is a welded portion composed of cylindrical portions or a welded portion composed of a cylindrical portion and a hemispherical portion, so that for the welded portion in the peripheral direction which is formed in the pressure vessel, a track with a rack arranged is installed in the neighborhood of the outside surface of the pressure vessel when building the pressure vessel, and on the track, the welded portion inspection apparatus for inspecting the welded portion is loaded, thus the inside welded portion of the pressure vessel is inspected.

On the other hand, when the track for loading the welded portion inspection apparatus is not installed in the neighborhood of the welded portion of the pressure vessel, as an apparatus for inspecting the inside welded portion of the pressure vessel from the outside of the pressure vessel, in the Japanese Patent Laid-open No. 11(1999)-194119 of a prior art, an art relating to a welded portion inspection apparatus for inspecting the welded portion of the pressure vessel from the outside of the pressure vessel using a welded portion inspection apparatus of a trackless type requiring no track is disclosed.

The welded portion inspection apparatus of the trackless type disclosed in the Japanese Patent Laid-open No. 11(1999)-194119 is adsorbed to the outside surface of the pressure vessel due to magnetic force by a drive portion with a plurality of magnets connected by a chain, is moved to the position of the welded portion, and thereby inspects the welded portion of the pressure vessel.

In the main unit of the welded portion inspection apparatus, a shaft of the drive portion (the drive shaft) that is a support for moving the main unit and another shaft (the scan shaft) for permitting the inspection sensor arranged in the orthogonal direction to the drive shaft to scan, are loaded.

And, the welded portion inspection apparatus is structured so that by the drive shaft as a support for permitting the inspection sensor to make contact with the outside wall surface of the pressure vessel, the inspection apparatus is moved in parallel with the weld line of the welded portion of the pressure vessel, and the welded portion is scanned by the sensor using the scan shaft, thus the inspection of the inside welded portion of the pressure vessel is performed from the outside of the pressure vessel.

The welded portion inspection apparatus for scanning the outside surface of the pressure vessel is of the trackless type, so that the position of the main unit of the welded portion inspection apparatus is shifted during movement, though a discrimination rail is installed almost parallel with the weld line separately from the main unit of the welded portion inspection apparatus, and the discrimination rail is detected by the detection sensor loaded on the main unit of the welded portion inspection apparatus, thus the main unit of the welded portion inspection apparatus can be moved in parallel with the weld line.

Further, in the Japanese Patent No. 2619020 of a prior art, an art relating to a welded portion inspection apparatus of a hanging type equipped with a guide rail for permitting an inspection apparatus to access the neighborhood of an inside welded portion of a pressure vessel from the inside of the pressure vessel of a nuclear power plant and performing the inspection of the welded portion of the pressure vessel from the inside of the pressure vessel is disclosed.

The welded portion inspection apparatus for inspecting the inside welded portion of the pressure vessel disclosed in the Japanese Patent No. 2619020 includes two axes as inspection axes, permits an inspection sensor to make contact with the inside wall surface of the pressure vessel and scan it using the two axes for inspection, and thereby inspects the inside welded portion of the pressure vessel from the inside of the pressure vessel.

Patent document 1: Japanese Patent Laid-open No. 11(1999)-194119

Patent document 2: Japanese Patent No. 2619020

### SUMMARY OF THE INVENTION

On the other hand, in the nuclear power plant, on the outer peripheral side of the pressure vessel, a cylindrical insulation material is installed in the neighborhood of the pressure vessel, so that in the welded portion inspection apparatus for inspecting the inside welded portion of the pressure vessel from the outside of the pressure vessel, for example, having a constitution such as described in the Japanese Patent Laid-open No. 11(1999)-194119, a problem arises that it must move in a circular ring-shaped narrow gap between the outside surface of the pressure vessel and the inside surface of the cylindrical insulation material for surrounding the pressure vessel and furthermore, the drive axis as a support for moving the main unit of the welded portion inspection apparatus must also be installed in the narrow gap aforementioned.

Further, in the welded portion inspection apparatus for inspecting the welded portion from the inside of the pressure vessel, for example, having a constitution such as described in the U.S. Pat. No. 2,619,020, since there are two scan axes installed, the welded portion can be scanned finely by the sensor, though a plurality of intra-reactor structures are adjacent to each other in the neighborhood of the inside welded portion of the pressure vessel of the nuclear power plant, so that also in this case, the narrow welded portion must be similarly inspected.

Furthermore, the welded portion inspection apparatus is of the type of hanging the inspection apparatus inside the pressure vessel, so that only the visible range from the pressure vessel can be inspected, and moreover, inside the pressure vessel, operations other than the inspection of the welded portion are performed in a congested manner, so that the process adjustment of these operations is very difficult.

An object of the present invention is to provide a welded portion inspection apparatus of a reactor pressure vessel of a trackless type, when the welded portion inspection apparatus for inspecting the inside welded portion of the pressure vessel from the outside of the pressure vessel moves on the outside surface of the pressure vessel, for correcting the position shift from the position to be inspected and moving the welded portion inspection apparatus without installing a device for guiding the movement of the welded portion inspection apparatus, thereby accessing a narrow portion outside the pressure vessel.

The welded portion inspection apparatus of the reactor pressure vessel of the present invention comprising: a frame for moving on an outside surface of a reactor pressure vessel, which is provided with a scan portion having a sensor for detecting a state of a welded portion to be inspected, a first scan axis with a pedestal having the sensor installed for moving the sensor in a predetermined first direction to perform scanning, a second scan axis arranged in an orthogonal direction to the first scan axis for moving the first scan axis in a predetermined second direction, a first drive guidance portion installed in the first scan axis for moving the first scan axis with a pedestal having the sensor installed along the second scan axis, and a second drive guidance portion installed in the pedestal for moving the pedestal having the sensor along the first scan axis, and drive portions installed removably on both sides of the scan portion for moving the scan portion to a position of the welded portion to be inspected, and a motor for driving the drive portions, wherein the drive portions are comprising a plurality of magnets which are endlessly formed in a line.

Further, the welded portion inspection apparatus of the reactor pressure vessel of the present invention comprising: a frame for moving on an outside surface of a reactor pressure vessel, which is provided with a scan portion having a sensor for detecting a state of a welded portion to be inspected, a sensor for detecting a state of a welded portion to be inspected, a first scan axis with a pedestal having the sensor installed for moving the sensor in a predetermined first direction to perform scanning, drive guidance portion installed in the pedestal for moving the pedestal having the sensor along an arrangement direction of the first scan axis, and drive portions installed removably on both sides of the scan portion for moving the scan portion to a position of the welded portion to be inspected, and a motor for driving the drive portions, wherein the drive portions are comprising a plurality of magnets which are endlessly formed in a line.

According to the present invention, a welded portion inspection apparatus of a reactor pressure vessel of a trackless type, when the welded portion inspection apparatus for inspecting the inside welded portion of the pressure vessel from the outside of the pressure vessel moves on the outside surface of the pressure vessel, for correcting the position shift from the position to be inspected without installing a device for guiding the movement of the welded portion inspection apparatus, thereby moving the welded portion inspection apparatus, and accessing the narrow portion outside the pressure vessel can be realized.

### BRIEF DESCRIPTION OF THE DRAWINGS

FIG. 1 is a schematic block diagram showing the inspection apparatus of the welded portion between the reactor pressure vessel and an intra-reactor structure, which is an embodiment of the present invention,

FIG. 2 is a cross sectional view showing the state that the welded portion inspection apparatus of the embodiment shown in FIG. 1 scans the outside surface of the reactor pressure vessel,

FIG. 3 is a partial diagram of the welded portion inspection apparatus of the embodiment shown in FIG. 1 viewed from above,

FIG. 4 is a cross sectional view of the embodiment shown in FIG. 1 in the direction of A-A,

FIG. 5 is a cross sectional view of the embodiment shown in FIG. 1 in the direction of B-B, showing the state with the drive portion installed,

FIG. 6 is another cross sectional view of the embodiment shown in FIG. 1 in the direction of B-B, showing the state with the drive portion removed, and

FIG. 7 is a schematic block diagram showing the inspection apparatus of the welded portion between the reactor pressure vessel and an intra-reactor structure, which is another embodiment of the present invention.

### DETAILED DESCRIPTION OF THE INVENTION

The welded portion inspection apparatus of the reactor pressure vessel of the trackless type for inspecting the welded portion between the reactor pressure vessel and an intra-reactor structure, which is an embodiment of the present invention, will be explained below with reference to the accompanying drawings.

### Embodiment 1

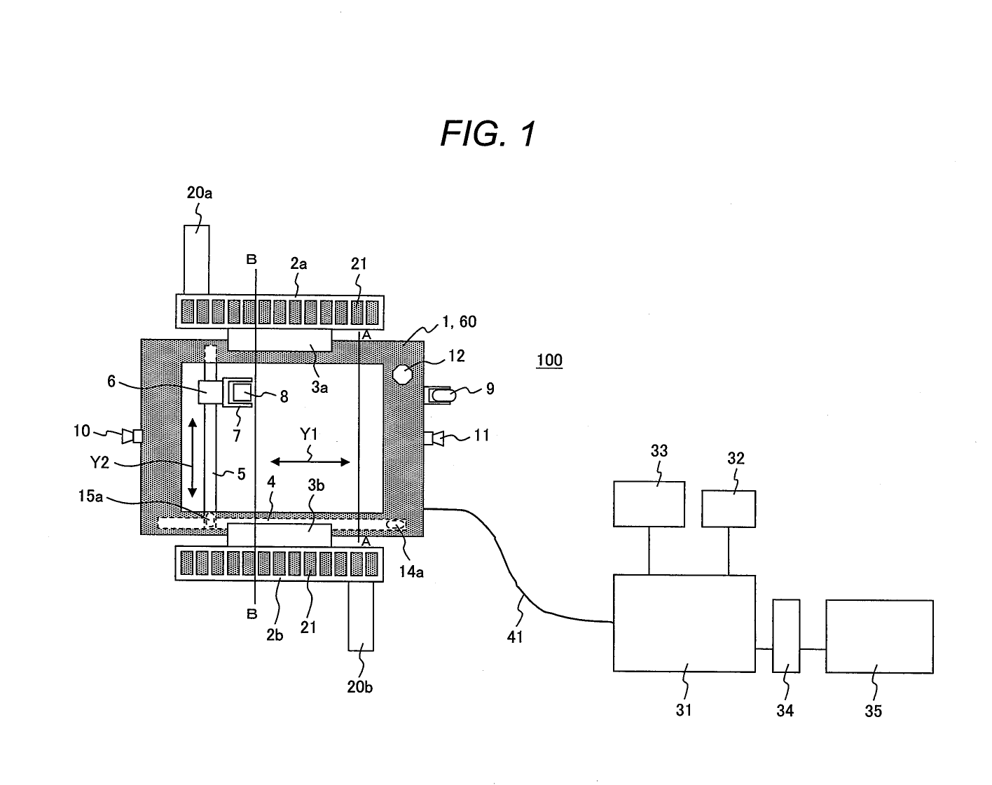

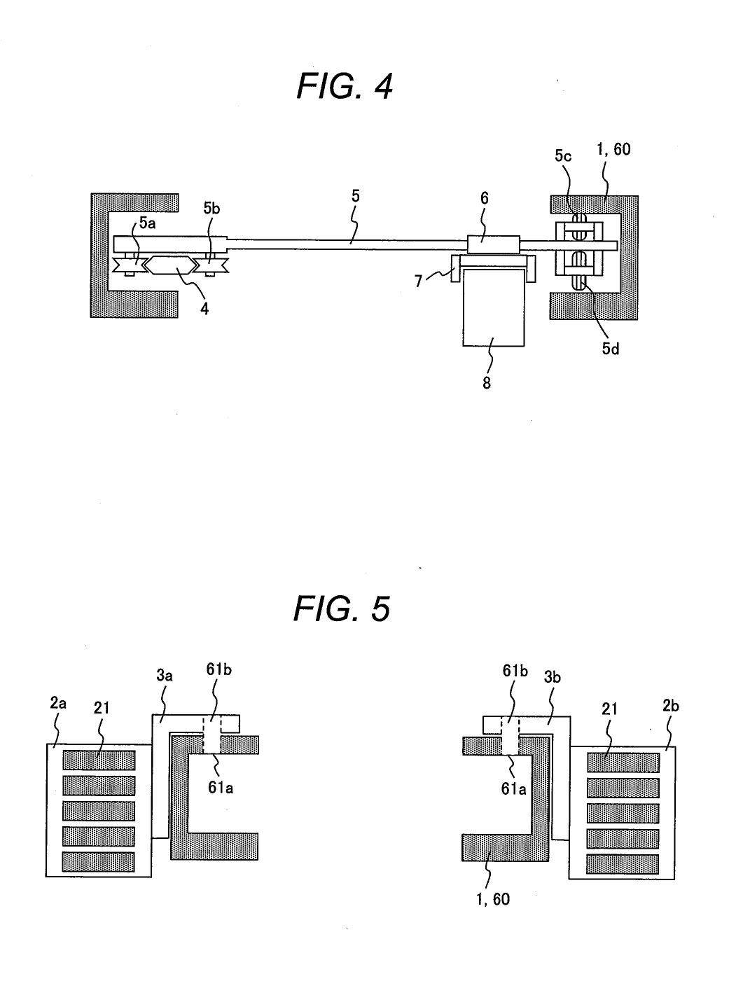

The welded portion inspection apparatus of the reactor pressure vessel of the trackless type for inspecting the welded portion between the reactor pressure vessel and the intra-reactor structure, which is an embodiment of the present invention, will be explained by referring to FIGS. 1 to 6.

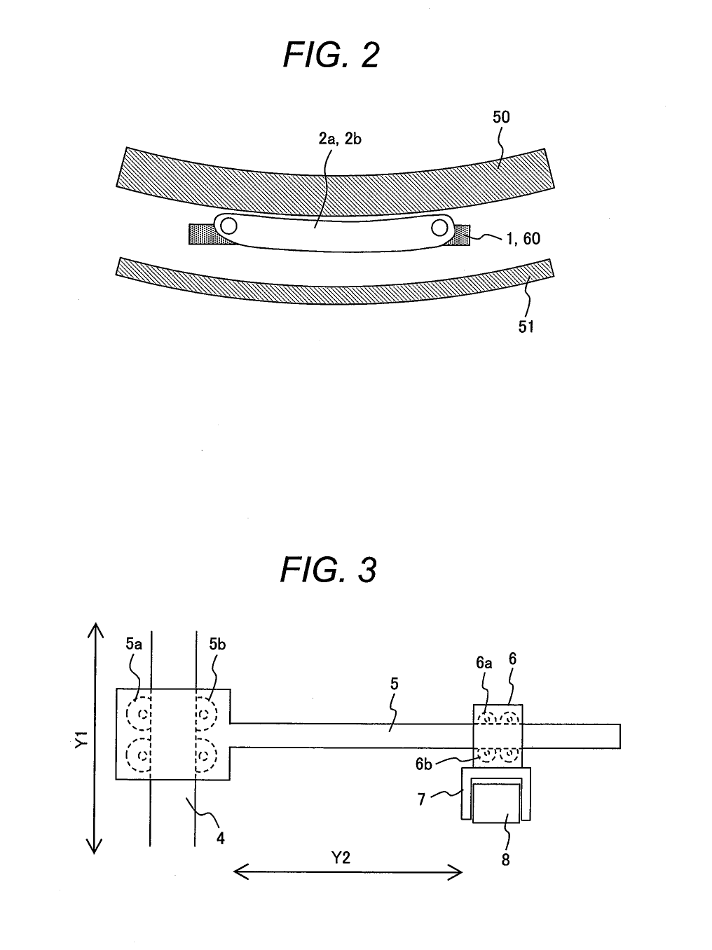

FIGS. 1 and 2 show a welded portion inspection apparatus 100 of this embodiment of the reactor pressure vessel of the trackless type for inspecting the welded portion between the reactor pressure vessel and an intra-reactor structure. The drawings show the state of the welded portion inspection apparatus 100 of the reactor pressure vessel of the trackless type of this embodiment, outside a reactor pressure vessel 50 showing a part of the section in the partial cross sectional view shown in FIG. 2, for scanning the very narrow circular ring-shaped portion between the pressure vessel 50 and an insulation material 51 along the outside surface of the pressure vessel 50 and inspecting the state of the welded portion.

The welded portion inspection apparatus 100 of the reactor pressure vessel of this embodiment is a welded portion inspection apparatus of the trackless type including two scan axes for operating the sensor for performing the inspection of the welded portion on the same plane without requiring installation of another apparatus for correcting the position shift between the welded portion of the reactor pressure vessel to be inspected and the main unit of the welded portion inspection apparatus 100.

Firstly, the schematic constitution of the welded portion inspection apparatus 100 of the reactor pressure vessel of this embodiment will be explained. As shown in FIG. 1, the welded portion inspection apparatus 100 of the reactor pressure vessel of this embodiment is composed of a frame 60 composing a scan portion 1 which is the main unit of the welded portion inspection apparatus and drive portions 2a and 2b which are respectively installed on both sides of the frame 60 and are driven by a motor 20.

The drive portions 2a and 2b are removably attached to the frame 60 of the scan portion 1 via drive portion removable portions 3a and 3b together with the motor 20.

The drive portions 2a and 2b respectively have a structure that a plurality of magnets 21 is endlessly connected in a line by a chain (not drawn). And, by the magnets 21 of the drive portions 2a and 2b, to the outside surface of the reactor pressure vessel 50, the drive portions 2a and 2b are adsorbed. To the motor 20 for driving the drive portions 2a and 2b, a driving current is supplied from a control unit 31 via a power cable 41.

To the frame 60 of the scan portion 1 of the welded portion inspection apparatus 100, as two scan axes positioned on the same plane, an X-axis 4 arranged in the longitudinal direction of the frame 60 and a Y-axis 5 arranged in the orthogonal direction to the X-axis 4 are attached.

On the Y-axis 5, a pedestal 6 having a sensor pressing portion 7 for pressing a sensor 8 of an ultrasonic probe for scanning the state of the welded portion of the pressure vessel 50 in the directions of arrows Y1 and Y2 to the surface of the pressure vessel 50 is installed and the pedestal 6 is structured so as to move in the axial direction of the Y-axis 5 (in the direction of the arrow Y2 which is the direction of the Y-axis). Further, the sensor 8 of the ultrasonic probe is attached to the sensor pressing portion 7 installed on the pedestal 6.

At one end of the Y-axis 5, respectively two tires 5a and 5b composing the drive guidance portion of the pedestal 6 including the sensor 8 which are driven by a motor (not drawn) are arranged so as to hold the X-axis 4 having a convex sectional shape from both sides and the Y-axis 5 is structured so as to move by the tires 5a and 5b on the frame 60 in the arrangement direction of the X-axis 4 (in the direction of the arrow Y1 which is the direction of the X-axis).

Further, in front of the frame 60 of the scan portion 1, a front confirmation camera 10 is installed and in the rear, a rear confirmation camera 11 is installed.

The scan portion 1 of the welded portion inspection apparatus 100 is structured as mentioned above, and the sensor 8 is pressed to the surface of the pressure vessel 50, thereby the welded portion inspection apparatus 100 is permitted to move, thus the sensor 8 can move in the directions of the arrows Y1 and Y2 and scan the welded portion of the pressure vessel 50. To move the pedestal 6 including the sensor 8 in the direction of the arrow Y1 of the X-axis 4, as mentioned above, by the rotation drive of the tires 5a and 5b driven by the motor (not drawn), the Y-axis 5 including the pedestal 6 is moved in the direction of the arrow Y1 of the X-axis 4.

Further, to move the pedestal 6 including the sensor 8 in the direction of the arrow Y2 of the Y-axis 5, by the rotation drive of tires 6a and 6b which compose the drive guidance portion of the pedestal 6 including the sensor 8 and are driven by a motor (not drawn) installed in the pedestal 6, the pedestal 6 is moved beforehand in the direction of the arrow Y2 of the Y-axis 5.

On the Y-axis 5, an X-axis moving rate detector 14a is installed and by the X-axis moving rate detector 14a, the moving rate of the pedestal 6 including the sensor 8 moving on the X-axis 4 in the direction of the arrow Y1 is detected.

Further, on the X-axis 4, a Y-axis moving rate detector 15a is installed and by the Y-axis moving rate detector 15a, the moving rate of the pedestal 6 including the sensor 8 moving on the Y-axis 5 in the direction of the arrow Y2 is detected.

On the pedestal 6 installed on the Y-axis 5, the sensor pressing portion 7 is installed and to the sensor pressing portion 7, the inspection sensor 8 for inspecting the welded portion formed on the surface of the pressure vessel 50 is attached.

The welded portion inspection apparatus 100 having the aforementioned constitution of this embodiment respectively drives the drive portions 2a and 2b installed on the frame 60 of the welded portion inspection apparatus 100 in which the plurality of magnets 21 are endlessly formed so as to access and move on the outside surface of the pressure vessel 50 within the narrow circular ring-shaped range surrounded by the pressure vessel 50 shown in FIG. 2 and the insulation material 51 on the outer peripheral side of the pressure vessel 50, presses the inspection sensor 8 onto the surface of the pressure vessel 50 by the sensor pressing portion 7 attached to the pedestal 6, moves (scans) the X-axis 4 and the Y-axis 5 respectively in the direction of the arrow Y1 and the direction of the arrow Y2, and thereby inspects the welded portion of the reactor pressure vessel.

To the frame 60 of the scan portion 1 of the welded portion inspection apparatus 100, a movement distance detector 9 for detecting the movement distance of the scan portion 1 in the X-axial direction is attached and detects the movement distance of the scan portion 1 in the X-axial direction by the driving of the drive portions 2a and 2b installed on the frame 60 of the scan portion 1. In front and rear of the frame 60 of the scan portion 1, the front confirmation camera 10 and the rear confirmation camera 11 are respectively attached, thus an interfered article in the front and rear of the welded portion inspection apparatus 100 can be confirmed.

Further, to detect the angle of inclination of the scan portion 1 to the horizontal direction, an inclination angle sensor 12 is attached to the frame 60 of the scan portion 1.

In the welded portion inspection apparatus 100 of this embodiment, as shown in FIG. 1, the control unit 31 for controlling the operation of inspection of the welded portion by the welded portion inspection apparatus 100 is installed and to the control unit 31, an operation device 32 for manually operating the driving of the drive portions 2a and 2b of the scan portion 1, thereby controlling the movement of the scan portion 1 is connected.

The control unit 31 is connected to the scan portion 1 with the cable 41 with various signal lines bundled and is structured so that detected signals by various sensors including the sensor 8 installed on the scan portion 1 are input to the control unit 31 via the cable 41 and an operation signal from the control unit 31 is output to motors 20a and 20b for respectively driving the drive portions 2a and 2b of the scan portion 1.

To the control unit 31, a control-state display PC 33 is connected and the control-state display PC 33 inputs detected signals which are detected respectively by the X-axis moving rate detector 14a, the Y-axis moving rate detector 15a, the movement distance detector 9 in the X-axial direction, and the inclination angle sensor 12, which are installed on the frame 60 of the scan portion 1, via the cable 41 and processes and displays the information.

Further, images picked up by the front confirmation camera 10 and the rear confirmation camera 11 of the frame 60 of the scan portion 1 are input to the control unit 31 via the cable 41 and are output to and displayed on a monitor 35 connected to the control unit 31 via a camera control unit (CCU) 34.

Next, the inspection system for inspecting the welded portion of the reactor pressure vessel by the welded portion inspection apparatus 100 of this embodiment will be explained. In FIGS. 1 to 6, FIG. 4 shows a cross sectional view of the drawing shown in FIG. 1 in the direction of A-A and the frame 60 of the scan portion 1 is formed in a U-shaped cross sectional shape. The X-axis 4 and the Y-axis 5 installed on the scan portion 1 respectively have a cross sectional shape of a bead on an abacus like a hexagon crushed vertically.

At one end of the Y-axis 5 (the left side portion of FIG. 3), respectively two tires 5a and 5b with the center of the outer peripheral side depressed are attached, and the tires 5a and 5b are arranged so as to hold the convex part of the X-axis 4, so that the tires 5a and 5b are prevented from falling and the tires 5a and 5b are driven by a motor not drawn, thus the Y-axis 5 including the pedestal 6 having the sensor 8 can move in the direction of the arrow Y1 (in the arrangement direction of the X-axis 4) for the X-axis 4.

Further, at the other end of the Y-axis 5 (the right side portion of FIG. 3), a wheel 5c and a wheel 5d for moving on the top of the U-shaped inner wall and the lower surface of the inner wall of the frame 60 are respectively installed, thus the Y-axis 5 is prevented from falling slantwise.

Similarly, to the pedestal 6 installed on the Y-axis 5, the tires 6a and 6b driven by a motor not drawn are attached, and the tires 6a and 6b are driven by the motor, thus the pedestal 6 having the sensor 8 can move on the Y-axis 5 in the direction of the arrow Y2 (in the arrangement direction of the Y-axis 5).

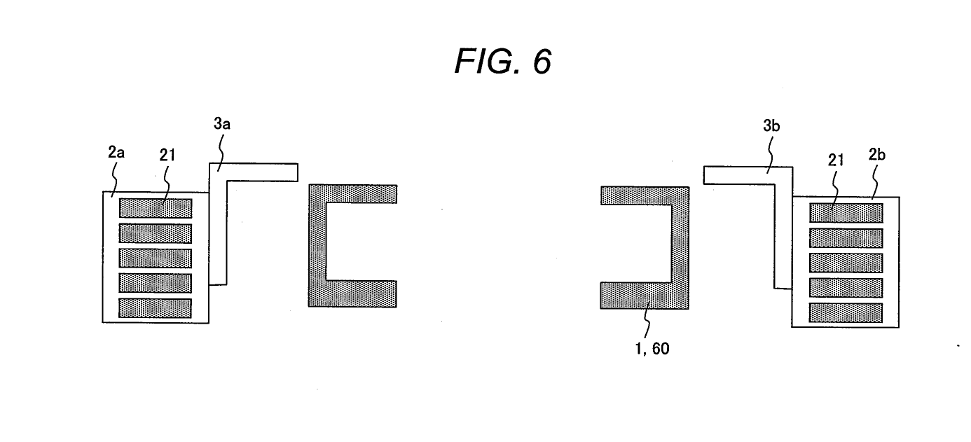

FIGS. 5 and 6 respectively show a cross sectional view of the drawing shown in FIG. 1 in the direction of B-B. In the cross sectional view shown in FIG. 5, on both sides of the frame 60 of the scan portion 1, the drive portions 2a and 2b are attached via the drive portion removable portions 3a and 3b.

The drive portion removable portions 3a and 3b, as shown in FIG. 5, are screwed, for example, by inserting a screw 61b into a thread hole 61a formed in the frame 60, so that the drive portion removable portions 3a and 3b can be easily removed from the frame 60.

Therefore, when there is a very narrow entrance existing up to the welded portion to be inspected of the pressure vessel, this side of the narrow entrance, as shown in FIG. 6, the screw 61b is taken out from the hole 61a of the frame 60, thus the drive portion removable portions 3a and 3b are removed from the frame 60, and the size of the welded portion inspection apparatus 100 in the width direction is made smaller, thus the welded portion inspection apparatus 100 passes through the narrow entrance of the narrow portion.

And, after the welded portion inspection apparatus 100 passes through the narrow entrance, the screw 61b, as shown in FIG. 5, is fixed to the hole 61a of the frame 60, and the drive portion removable portions 3a and 3b are mounted again on the frame 60, thus the welded portion inspection apparatus 100 can be easily transferred to the welded portion of the reactor pressure vessel to be inspected.

According to the welded portion inspection apparatus 100, a welded portion inspection apparatus of a trackless type for moving on the outside surface of the pressure vessel by the drive portions 2a and 2b of the welded portion inspection apparatus 100, accessing the narrow portion of the pressure vessel without requiring another apparatus for correcting the position shift from the position to be inspected of the welded portion, and easily inspecting the welded portion of the reactor pressure vessel can be realized.

According to this embodiment, a welded portion inspection apparatus of a reactor pressure vessel of a trackless type, when the welded portion inspection apparatus for inspecting the inside welded portion of the pressure vessel from the outside of the pressure vessel moves on the outside surface of the pressure vessel, for correcting the position shift from the position to be inspected without installing a device for guiding the movement of the welded portion inspection apparatus, thereby moving the welded portion inspection apparatus, and accessing the narrow portion outside the pressure vessel can be realized.

### Embodiment 2

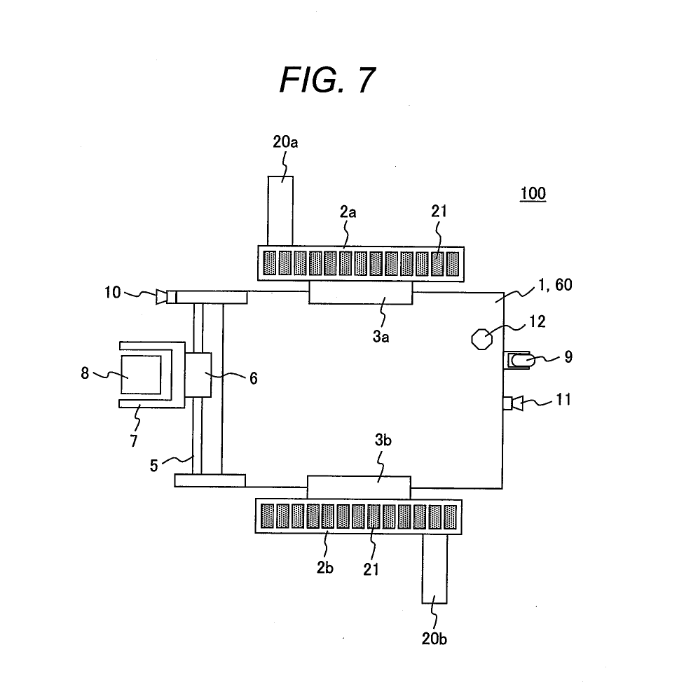

The welded portion inspection apparatus, which is another embodiment of the present invention, of the reactor pressure vessel of the trackless type for inspecting the welded portion between the reactor pressure vessel and an intra-reactor structure will be explained by referring to FIG. 7.

The welded portion inspection apparatus of the trackless type of this embodiment shown in FIG. 7 is the same as the welded portion inspection apparatus of the reactor pressure vessel of the trackless type of the preceding embodiment shown in FIGS. 1 to 6 in the basic structure, so that the explanation of the constitution common to the two is omitted and the different constitution will be explained below.

In the welded portion inspection apparatus 100 of the reactor pressure vessel of the trackless type of this embodiment shown in FIG. 7, to simplify the structure, the X-axis 4 arranged in the longitudinal direction of the frame 60 of the preceding embodiment is removed.

Further, the Y-axis 5 is directly attached to the frame 60, so that a structure where the tires 5a and 5b driven by the motor are removed is realized.

By the welded portion inspection apparatus 100 of the reactor pressure vessel of the trackless type having the aforementioned constitution of this embodiment, a welded portion inspection apparatus of a reactor pressure vessel of a trackless type, when the welded portion inspection apparatus for inspecting the inside welded portion of the pressure vessel from the outside of the pressure vessel moves on the outside surface of the pressure vessel, for correcting the position shift from the position to be inspected without installing a device for guiding the movement of the welded portion inspection apparatus, thereby moving the welded portion inspection apparatus, and accessing the narrow portion outside the pressure vessel can be realized.

The present invention can be applied to the welded portion inspection apparatus of the reactor pressure vessel of the trackless type for inspecting the welded portion between the reactor pressure vessel and an intra-reactor structure.

What is claimed is:

1. A welded portion inspection apparatus of a reactor pressure vessel comprising:
a frame for moving on an outside surface of a reactor pressure vessel, which is provided with a scan portion having a sensor for detecting a state of a welded portion to be inspected, a first scan axis with a pedestal having the sensor installed for moving the sensor in a predetermined first direction to perform scanning, a second scan axis arranged in an orthogonal direction to the first scan axis for moving the first scan axis in a predetermined second direction, a first drive guidance portion installed in the first scan axis for moving the first scan axis with a pedestal having the sensor installed along the second scan axis, and a second drive guidance portion installed in the pedestal for moving the pedestal having the sensor along the first scan axis, and
drive portions installed removably on both sides of the scan portion for moving the scan portion to a position of the welded portion to be inspected, and a motor for driving the drive portions,
wherein the drive portions are comprising a plurality of magnets which are endlessly formed in a line.

2. The welded portion inspection apparatus of a reactor pressure vessel according to claim 1, wherein:
the first scan axis and the second scan axis are arranged so that each axis is positioned on a same plane.

3. The welded portion inspection apparatus of a reactor pressure vessel according to claim 1, wherein:
the sensor is structured so as to be installed in a sensor pressing portion arranged on the pedestal installed on the first scan axis, thereby scan the outside surface of the reactor pressure vessel.

4. The welded portion inspection apparatus of a reactor pressure vessel according to claim 1, wherein:
the frame of the scan portion is further provided with a first moving rate detector for detecting a moving rate in the predetermined first direction and a second moving rate detector for detecting a moving rate in the predetermined second direction, and
the welded portion inspection apparatus is further provided with a control unit for outputting an operation signal to the motor for driving the drive portion on the basis of the moving rates detected by the moving rate detectors.

5. A welded portion inspection apparatus of a reactor pressure vessel comprising:
a frame for moving on an outside surface of a reactor pressure vessel, which is provided with a scan portion having a sensor for detecting a state of a welded portion to be inspected, a sensor for detecting a state of a welded portion to be inspected, a first scan axis with a pedestal having the sensor installed for moving the sensor in a predetermined first direction to perform scanning,
drive guidance portion installed in the pedestal for moving the pedestal having the sensor along an arrangement direction of the first scan axis, and
drive portions installed removably on both sides of the scan portion for moving the scan portion to a position of the welded portion to be inspected, and a motor for driving the drive portions,
wherein the drive portions are comprising a plurality of magnets which are endlessly formed in a line.

6. The welded portion inspection apparatus of a reactor pressure vessel according to claim 5, wherein:
the frame of the scan portion is further provided with a first moving rate detector for detecting a moving rate in the predetermined first direction, and
the welded portion inspection apparatus is further provided with a control unit for outputting an operation signal to the motor for driving the drive portion on the basis of the moving rate detected by the moving rate detector.
